(19) United States
(12) Patent Application Publication
(10) Pub. No.: US 2021/0195691 A1
(43) Pub. Date: Jun. 24, 2021

(54) ELECTRONIC DRIVING MECHANISM FOR ELECTRIC HEATER

(71) Applicant: Gaoli Ge, Ningbo (CN)

(72) Inventor: Gaoli Ge, Ningbo (CN)

(21) Appl. No.: 16/757,986

(22) PCT Filed: Apr. 12, 2019
(86) PCT No.: PCT/CN2019/082533

§ 371 Date: Apr. 21, 2020

(30) Foreign Application Priority Data
Jun. 4, 2018 (CN) 201810564210.1

(51) Int. Cl. H05B 1/02; G06K 9/00; H05B 6/06

(52) U.S. Cl. CPC H05B 1/0202; H05B 6/06; G06K 9/00362

(57) ABSTRACT

An automatic switching device is described to switch on an electric heater based on a user wearing a down jacket and switch off the electric heater based on the user not wearing a down jacket. The automatic switching is based on an image collection unit collecting an image of the user, and an image processing unit processing the image to determine if down jacket is in the image. The image collection unit may be adjusted to a position so that it may collect the image between a shoulder and a waist of the user. The adjustment of the position is based on a measured distance between the image collection unit and a floor by an ultrasonic transducer. Since the velocity of sound in air varies with the ambient temperature, a temperature unit is utilized to detect the ambient temperature so that an accurate velocity of sound may be retrieved from a table.

### CROSS REFERENCE TO RELATED APPLICATIONS

This application is a U.S. national stage entry of PCT International Application No. PCT/CN2019/082533, titled “Electronic Drive Mechanism for Electric Heater” and filed Apr. 12, 2019, which claims priority to Chinese Patent Application No. 201810564210.1, filed Jun. 4, 2018, each of which is hereby incorporated by reference in its entirety.

### FIELD OF INVENTION

The present invention relates to the field of household appliances, in particular to an electronic driving mechanism for an electric heater.

### BACKGROUND OF INVENTION

The popularity of electric heaters stems from their many advantages. Since electricity is their power source, electric heaters generally have no emission, pollution, or noise. Heating by electric heaters is immediate. As soon as the power is turned on, electric heaters become hot and as soon as the power is turned off, the heating stops. Portable electric heaters may be moved around freely. Therefore, even in households with central heating, electric heaters may be used as supplemental heating. Some smart electric heater models may be timed, set to fixed temperatures, or adjusted for each room in which they are used, which makes the use of electric heaters even more convenient. Electric heaters have a high power conversion rate of up to 100%. Their purchasing and operating costs are relatively low, and their features may facilitate centralizing heating or collecting charges. With proper power management features, more power may be saved and the energy cost associated with electric heaters may be further reduced.

### SUMMARY OF THE INVENTION

To overcome the drawbacks of a conventional electric heater with the technical issue of its low heating efficiency, the present invention provides an electronic driving mechanism for an electric heater, wherein the edge intensity of an image is determined according to the gradient statistics of the image in order to set a different edge enhancement strategy; the threshold of each sub-image processed with a homomorphic filtering process, a histogram equalization processing and an image division is adjusted to further reduce the recognition range of the image, so as to decrease the data volume for subsequent image processing; an ultrasonic wave detection method is used to confirm the current position of an on-site collection device in order to improve the position detection accuracy, and a temperature-speed comparison table is introduced to keep a corresponding ultrasonic wave propagation speed of each temperature range while using a vertical control motor to perform an instant correction of the current position of the on-site collection device to ensure the quality of the collected image; and the aforementioned high precision processing will turn on the power supply device of the electric heater if, for example, a down jacket existence signal is detected, or else the aforementioned high precision processing will turn off the power supply device of the electric heater, so as to improve the heating efficiency of the electric heater.

According to one aspect of the present invention, the invention provides an electric heater electronic driving mechanism, comprising:

a power supply device, installed onto a base of an electric heater, and coupled to a mains connection interface, for providing a mains electricity supply to the electric heater; and

an electronic driving mechanism, installed onto the electric heater, and coupled to the power supply device, for controlling the ON or OFF operation of the power supply device.

More specifically, the electric heater electronic driving mechanism may further comprise:

an on-site collection device, installed onto the base of the electric heater, for performing an on-site image data collection of a site where the electric heater is situated to obtain a corresponding on-site collected image, and output the on-site collected image; and

an ultrasonic transmitting device, installed onto the on-site collection device, for transmitting an ultrasonic signal towards ground, and recording the time of transmitting the ultrasonic signal.

More specifically, the electric heater electronic driving mechanism may further comprise:

an ultrasonic receiving device, installed onto the on-site collection device, and disposed near the ultrasonic transmitting device, for receiving the ultrasonic signal transmitted towards the ground by the ultrasonic transmitting device and reflected from the ground, and recording the time of receiving the ultrasonic signal transmitted towards the ground by the ultrasonic transmitting device and reflected from the ground; and

an air-temperature testing device, installed onto the on-site collection device, for detecting an air temperature of an environment where the on-site collection device is situated and using the air temperature as a current air temperature output.

More specifically, the electric heater electronic driving mechanism may further comprise:

an embedded processing device, installed on the on-site collection device, and coupled to the air-temperature testing device, the ultrasonic transmitting device and the ultrasonic receiving device, for calculating a vertical height of the on-site collection device from the ground as a current height output based on the current air temperature, the time of transmitting the ultrasonic signal and the time of receiving the ultrasonic signal; and

a FLASH storage device, coupled to the embedded processing device, for storing a temperature-speed comparison table, and the temperature-speed comparison table having an ultrasonic wave propagation speed corresponding to each temperature range and using the temperature range as an index value, and the FLASH storage device further storing a predetermined height which is a shooting height set by the on-site collection device.

More specifically, the electric heater electronic driving mechanism may further comprise:

a vertical control motor, coupled to the embedded processing device and the on-site collection device, for receiving the current height and the predetermined height, and controlling the position of the on-site collection device to be adjusted from the current height to the predetermined height, and the vertical control motor being used for adjusting the position of the on-site collection device from the current height to the predetermined height, and then transmitting an adjustment completion signal;

a homomorphic filtering device, coupled to the on-site collection device, for receiving the on-site collected image, and executing a homomorphic filtering process of the on-site collected image to obtain a corresponding homomorphic filtered image, wherein the larger the noise amplitude of the on-site collected image, the larger the strength of executing the homomorphic filtering process;

an equalization processing device, coupled to the homomorphic filtering device, for receiving the homomorphic filtered image, and executing a histogram equalization processing of the homomorphic filtered image to obtain a corresponding histogram equalization image;

a first threshold fetching device, coupled to the equalization processing device, for receiving the histogram equalization image, to confirm an overall division threshold corresponding to the histogram equalization image based on a distribution of a pixel value of each pixel point in the histogram equalization image;

a first parameter analysis device, for receiving the histogram equalization image, and executing a contrast analysis of the histogram equalization image to obtain and output a corresponding contrast;

a first division processing device, coupled to the first parameter analysis device, for receiving the contrast, and executing an image division processing of the histogram equalization image based on the contrast to obtain a plurality of sub-images, wherein the higher the contrast, the larger the quantity of the sub-images;

a second threshold fetching device, coupled to the first division processing device, for receiving the plurality of sub-images, confirming an area division threshold corresponding to the sub-image based on a distribution of a pixel value of each pixel point in each sub-image, and outputting each area division threshold corresponding to each sub-image;

a first numerical value adjusting device, coupled to the second threshold fetching device and the first threshold fetching device, for receiving the overall division threshold and each area division threshold, and executing a numerical value adjustment of each area division threshold based on the overall division threshold to obtain an adjusted area division threshold as an area adjustment threshold output;

a second division processing device, coupled to the first numerical value adjusting device, for executing a division processing of the corresponding area adjustment threshold of each sub-image to obtain a corresponding target sub-image, and executing a combination of all target sub-images to obtain and output a combined image;

a linear filter device, coupled to the second division processing device, for receiving the combined image, and executing a linear filtering process of the combined image to obtain and output a corresponding linear filtered image;

a signal recognition device, coupled to the linear filter device, for receiving the linear filtered image, and recognizing an edge resolution of the linear filtered image, and issuing a strong edge control signal when the edge resolution is over-limit, and issuing a weak edge control signal when the edge resolution is not over-limit;

a trigger processing device, coupled to the signal recognition device, for executing an edge enhancement of the linear filtered image corresponding to the edge resolution when receiving the weak edge control signal, wherein the larger the edge resolution of the trigger processing device, the smaller the strength of the edge enhancement of the linear filtered image corresponding to the edge resolution, and outputting a trigger processing image obtained after executing the edge enhancement of the linear filtered image corresponding to the edge resolution;

an object recognition device, coupled to the trigger processing device, for receiving the trigger processing image, and executing an object recognition of the trigger processing image in order to divide each object pattern from the trigger processing image, and using an image characteristic of each object pattern as an input of a neural network, and the neural network using each trained parameter to output an object type corresponding to each object pattern, and outputting a down jacket existence signal when the object type corresponding to the object pattern is a down jacket; wherein the object recognition device is further used to output a down jacket non-existence signal when the object type corresponding to the object pattern is a non-down jacket; and the electronic driving device is further coupled to the object recognition device, for turning on the power supply device when receiving the down jacket existence signal.

More specifically, the trigger processing device of the electric heater electronic driving mechanism may stop the implementation of the linear filtered image and the corresponding edge enhancement of the edge resolution when receiving the strong edge control signal.

More specifically, the numerical value adjustment of each area division threshold based on the overall division threshold in the first numerical value adjusting device of the electric heater electronic driving mechanism may further comprise: an execution of a numerical value adjustment of the area division threshold based on the difference between the overall division threshold and each area division threshold.

More specifically, the execution of the numerical value adjustment of the area division threshold based on the difference between the overall division threshold and each area division threshold in the first numerical value adjusting device of the electric heater electronic driving mechanism may further comprise a condition of the adjusted area division threshold equal to one-quarter of the sum of the area division threshold and the difference.

### BRIEF DESCRIPTION OF THE DRAWING

FIG. 1 is a schematic view of an electronic driving mechanism applied in an electric heater in accordance with an embodiment the present invention.

### DESCRIPTION OF THE PREFERRED EMBODIMENTS

In the following description, reference is made to the figures identified above, which illustrate various embodiments in which aspects described herein may be practiced. Other embodiments may be used. Structural and functional modifications may be made without departing from the scope described herein. Various aspects are capable of other embodiments and of being practiced or being carried out in different ways.

Electric heaters may be categorized by their operation into oil-filled radiator electric heaters, hot air heaters and radiator heaters, and may be identified by their external appearance. Oil-filled radiator electric heaters are the most common electric heaters in the market, and they may have a common shape very similar to a household radiator set. Hot air heaters may be categorized into a bathroom type and a non-bathroom type, for example, and the bathroom type may have the features of small volume, strong blast, and fast heating effect and adopt a fully enclosed design to ensure the safety of use; and the non-bathroom type (such as the type of wall heaters used in bedrooms) may have a shape similar to an air-conditioner. Radiator heaters may have a shape similar to an electric fan, except the vanes and rear net cover are substituted by an electric heating component and an arcuate reflector respectively.

To overcome the deficiencies of the prior art discussed above, aspects of the present disclosure may overcome the corresponding technical issues by providing an electric heater electronic driving mechanism in accordance with the features discussed herein.

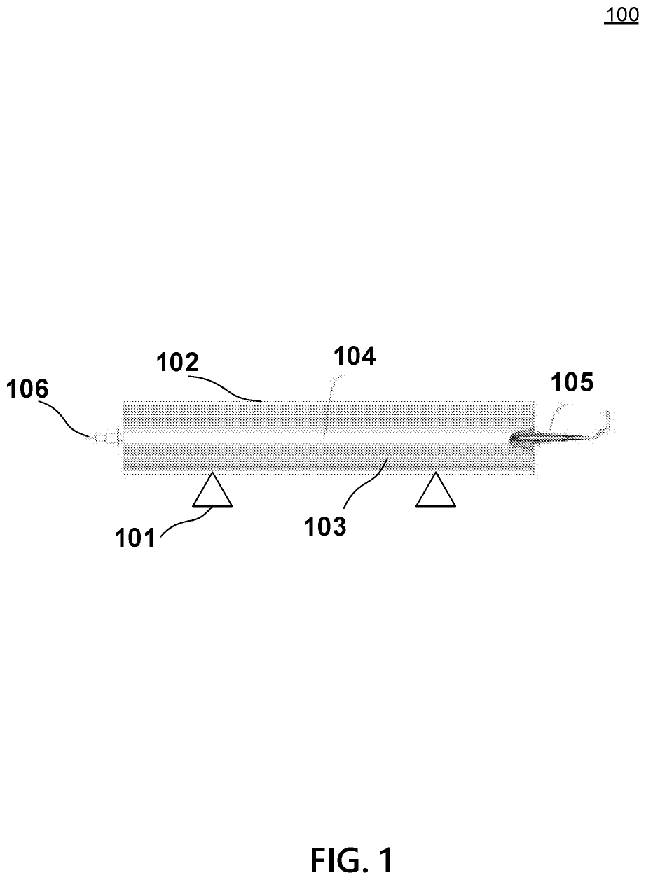

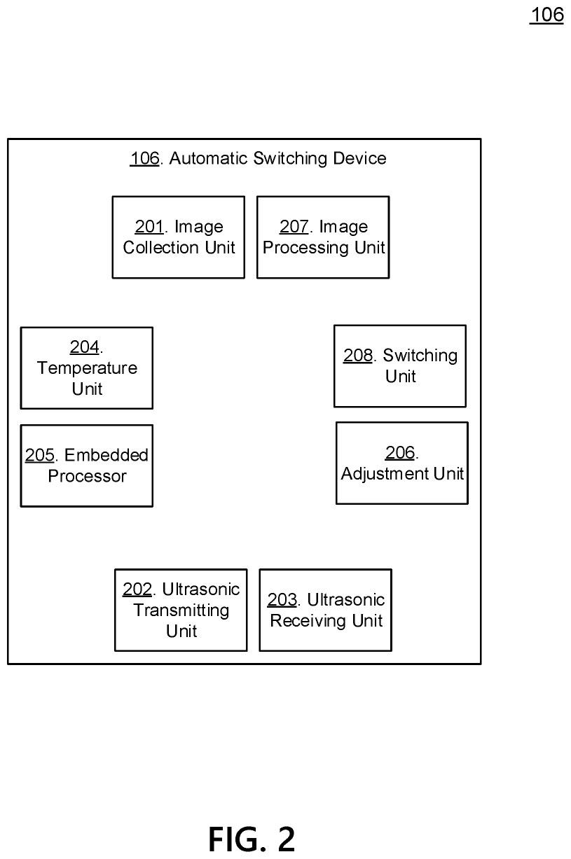

With reference to FIG. 1 for a schematic view of an electronic driving mechanism applied to an electric heater in accordance with an embodiment of this invention, the numeral 2 of FIG. 1 represents a heat source and the numeral 1 of FIG. 1 represents a container for storing a heating medium.

The electric heater electronic driving mechanism comprises:

a power supply device, installed onto a base of an electric heater, and coupled to a mains connection interface, for providing a mains electricity supply to the electric heater; and

an electronic driving device, installed onto the electric heater, and coupled to the power supply device, for controlling the ON or OFF operation of the power supply device.

The specific structure of the electric heater electronic driving mechanism of this invention will be described in detail below.

The electric heater electronic driving mechanism further comprises:

an on-site collection device, installed onto the base of the electric heater, for performing an on-site image data collection of a site at where the electric heater is situated to obtain a corresponding on-site collected image, and output the on-site collected image; and

an ultrasonic transmitting device, installed onto the on-site collection device, for transmitting an ultrasonic signal towards ground, and recording the time of transmitting the ultrasonic signal.

The electric heater electronic driving mechanism further comprises:

an ultrasonic receiving device, installed onto the on-site collection device, and disposed near the ultrasonic transmitting device, for receiving the ultrasonic signal transmitted towards the ground by the ultrasonic transmitting device and reflected from the ground, and recording the time of receiving the ultrasonic signal transmitted towards the ground by the ultrasonic transmitting device and reflected from the ground; and

an air-temperature testing device, installed onto the on-site collection device, for detecting an air temperature of an environment at where the on-site collection device is situated and using the air temperature as a current air temperature output.

The electric heater electronic driving mechanism further comprises:

an embedded processing device, installed on the on-site collection device, and coupled to the air-temperature testing device, the ultrasonic transmitting device and the ultrasonic receiving device, for calculating a vertical height of the on-site collection device from the ground as a current height output based on the current air temperature, the time of transmitting the ultrasonic signal and the time of receiving the ultrasonic signal; and

a FLASH storage device, coupled to the embedded processing device, for storing a temperature-speed comparison table, and the temperature-speed comparison table having an ultrasonic wave propagation speed corresponding to each temperature range and using the temperature range as an index value, and the FLASH storage device further storing a predetermined height which is a shooting height set by the on-site collection device.

The electric heater electronic driving mechanism further comprises:

a vertical control motor, coupled to the embedded processing device and the on-site collection device, for receiving the current height and the predetermined height, and controlling the position of the on-site collection device to be adjusted from the current height to the predetermined height, and the vertical control motor being used for adjusting the position of the on-site collection device from the current height to the predetermined height, and then transmitting an adjustment completion signal;

a homomorphic filtering device, coupled to the on-site collection device, for receiving the on-site collected image, and executing a homomorphic filtering process of the on-site collected image to obtain a corresponding homomorphic filtered image, wherein the larger the noise amplitude of the on-site collected image, the larger the strength of executing the homomorphic filtering process;

an equalization processing device, coupled to the homomorphic filtering device, for receiving the homomorphic filtered image, and executing a histogram equalization processing of the homomorphic filtered image to obtain a corresponding histogram equalization image;

a first threshold fetching device, coupled to the equalization processing device, for receiving the histogram equalization image, to confirm an overall division threshold corresponding to the histogram equalization image based on a distribution of a pixel value of each pixel point in the histogram equalization image;

a first parameter analysis device, for receiving the histogram equalization image, and executing a contrast analysis of the histogram equalization image to obtain and output a corresponding contrast;

a first division processing device, coupled to the first parameter analysis device, for receiving the contrast, and executing an image division processing of the histogram equalization image based on the contrast to obtain a plurality of sub-images, wherein the higher the contrast, the larger the quantity of the sub-images;

network using each trained parameter to output an object type corresponding to each object pattern, and outputting a down jacket existence signal when the object type corresponding to the object pattern is a down jacket;

Wherein, the object recognition device is further used to output a down jacket non-existence signal when the object type corresponding to the object pattern is a non-down jacket.

Wherein, the electronic driving device is further coupled to the object recognition device, for turning on the power supply device when receiving the down jacket existence signal

The trigger processing device of the electric heater electronic driving mechanism stops the implementation of the linear filtered image and the corresponding edge enhancement of the edge resolution when receiving the strong edge control signal.

The numerical value adjustment of each area division threshold based on the overall division threshold in the first numerical value adjusting device of the electric heater electronic driving mechanism further comprises: an execution of a numerical value adjustment of the area division threshold based on the difference between the overall division threshold and each area division threshold.

The execution of the numerical value adjustment of the area division threshold based on the difference between the overall division threshold and each area division threshold in the first numerical value adjusting device of the electric heater electronic driving mechanism further comprises a condition of the adjusted area division threshold equal to one-quarter of the sum of the area division threshold and the difference.

In addition, the principle of the ultrasonic transmitting device and its ultrasonic ranging is described as follows: The ultrasonic wave transmitter transmits an ultrasonic wave in a direction and starts timing during the transmission, and ultrasonic waves propagate in air and return immediately when encountering an obstacle. Once the ultrasonic receiver has received the reflected waves, it will stop timing immediately. The propagation speed of the ultrasonic wave in air is 340 m/s, so that the distance (s) of the ultrasonic receiver from the obstacle can be calculated by the time (t) recorded by a timer according to the equation s=340t/2. This is the so-called “Time-Difference-Of-Arrival (TDOA)” measurement method. The principle of ultrasonic ranging is to use the known propagation speed of the ultrasonic wave in air to measure the time when the sound waves is reflected back after encountering the obstacle, so that the actual distance from the point of transmission to the obstacle can be calculated by the time difference between the transmission and receipt of ultrasonic wave. The principle of ultrasonic ranging is the same as radar.

However, the propagation speed of the ultrasonic wave in air is actually a variable and varies with ambient temperature, so that it is necessary to take the ambient temperature into consideration for calculating the propagation speed of the ultrasonic wave in air to improve the accuracy of the ultrasonic ranging.

Ultrasonic ranging is mainly used to measure distance in the areas of reminding drivers for reversing a motor vehicle, or making measurements in a construction site or an industrial site. Although the current range of the distance measurement can reach up to hundreds of meters, the precision of measurement can only reach a level of centimeters.

The electric heater electronic driving mechanism of this invention can overcome the technical issues of the conventional electric heater and provide an effective driving mechanism that uses gradient statistics based on an image to determine the edge intensity of an image, so as to decide different edge enhancement strategies. By adjusting the threshold of each sub-image of the image processed by the homomorphic filtering process, histogram equalization processing and image division, the image recognition range is further reduced to decrease the data volume of subsequent image processing. The ultrasonic wave detection method is provided to confirm the current position of the on-site collection device in order to improve the position detection accuracy, and the temperature-speed comparison table is introduced to store the corresponding ultrasonic wave propagation speed of each temperature range, and the vertical control motor is used at the same time to execute an instant correction of the current position of the on-site collection device to ensure the quality of the collected image. By the aforementioned high precision processing, the power supply device of the electric heater is turned on when the down jacket existence signal is received, or else the power supply device is turned off, so as to improve the heating efficiency of the electric heater and overcome the aforementioned technical issues of the conventional electric heaters.

While the invention has been described by means of specific embodiments, numerous modifications and variations could be made thereto by those skilled in the art without departing from the scope and spirit of the invention set forth in the claims.

1-8. (canceled)

9. An automatic switching device configured to be installed onto an electric heater, wherein the electric heater comprises a base, a body, one or more heating elements, and a power cord configured to be plugged into a power outlet to provide power supply to the electric heater, the automatic switching device comprising:
an image collection unit configured to be installed onto the body of the electric heater, and configured to collect an image of a user from where the electric heater is situated;
an ultrasonic transmitting unit configured to be installed onto the image collection unit, and configured to transmit an ultrasonic signal towards a floor;
an ultrasonic receiving unit configured to be installed onto the image collection unit and next to the ultrasonic transmitting unit, and configured to receive the ultrasonic signal reflected from the floor;
a temperature unit configured to be installed onto the image collection unit, the temperature unit comprising:
a temperature sensor configured to detect an ambient air temperature around where the electric heater is situated; and
a non-volatile storage medium storing a table of velocities of sound in air corresponding to different temperatures;
an embedded processor configured to be installed onto the image collection unit, and configured to calculate a distance between the image collection unit and the floor based on:
a velocity of sound in air based on a comparison of a temperature detected by the temperature sensor and the table of velocities of sound in air corresponding to different temperatures; and
a period of time from a time the ultrasonic signal is transmitted by the ultrasonic transmitting unit towards the floor to a time the ultrasonic signal is reflected from the floor and received by the ultrasonic receiving unit;
an adjustment unit configured to be installed onto the image collection unit, and configured to adjust, based on the calculated distance between the image collection unit and the floor, a position of the image collection unit such as that the image collection unit may collect the image of the user between a shoulder and a waist of the user, wherein the adjusting the position of the image collection unit comprises adjusting the position of the image collection unit to a predetermined position stored in the non-volatile storage medium;
an image processing unit configured to be installed onto the image collection unit, and configured to process the image of the user to determine whether the user is wearing a down jacket, the image processing unit comprising:
a homomorphic filtering device configured to be coupled to the image collection unit, and configured to receive the image of the user and execute a homomorphic filtering process of the image to obtain a corresponding homomorphically filtered image, wherein the higher the noise of the image is, the greater the homomorphic filtering of the image is;
an equalization processing device configured to be coupled to the homomorphic filtering device, and configured to receive the homomorphically filtered image and execute a histogram equalization process of the homomorphically filtered image to obtain a corresponding histogram equalization image;
a first threshold fetching device configured to be coupled to the equalization processing device, and configured to receive the histogram equalization image and confirm an overall division threshold corresponding to the histogram equalization image based on a distribution of a pixel value of each pixel in the histogram equalization image;
a first parameter analysis device configured to be coupled to the equalization processing device, and configured to receive the histogram equalization image and execute a contrast analysis of the histogram equalization image to obtain and output a corresponding contrast;
a first division processing device configured to be coupled to the first parameter analysis device, and configured to receive the contrast and execute an image division process of the histogram equalization image based on the contrast to obtain a plurality of sub-images, wherein the higher the contrast is, the larger the quantity of the sub-images is;
a second threshold fetching device configured to be coupled to the first division processing device, and configured to receive the plurality of sub-images and confirm a sub-area division threshold corresponding to each of the sub-images based on a distribution of a pixel value of each pixel in each sub-image;
a first numerical value adjusting device configured to be coupled to the second threshold fetching device and the first threshold fetching device, and configured to receive the overall division threshold and each sub-area division threshold and execute a numerical value adjustment for each sub-area division threshold based on the overall division threshold to obtain an adjusted sub-area division threshold for each sub-image;
a second division processing device configured to be coupled to the first numerical value adjusting device, and configured to execute a combining process of each of the sub-images with a high adjusted sub-area division threshold to obtain a combined image;
a linear filter device configured to be coupled to the second division processing device, and configured to receive the combined image and execute a linear filtering process of the combined image to obtain and output a corresponding linearly filtered image;
a signal recognition device configured to be coupled to the linear filter device, and configured to receive the linearly filtered image, recognize an edge resolution of the linearly filtered image, issue a strong edge control signal when the edge resolution is over-limit, and issue a weak edge control signal when the edge resolution is not over-limit;
a trigger processing device configured to be coupled to the signal recognition device, and configured to execute an edge enhancement of the linear filtered image corresponding to the edge resolution when receiving the weak edge control signal, wherein the larger the edge resolution of the trigger processing device, the smaller the strength of the edge enhancement of the linear filtered image corresponding to the edge resolution, and output a trigger processing image obtained after executing the edge enhancement of the linear filtered image corresponding to the edge resolution; and
an object recognition device configured to be coupled to the trigger processing device, and configured to receive the trigger processing image, execute an object recognition of the trigger processing image in order to recognize each object pattern from the trigger processing image, and use an image characteristic of each object pattern as an input of a neural network, wherein the neural network uses each trained parameter to output an object type corresponding to each object pattern, wherein the object recognition device outputs a down jacket existence signal when the object type corresponding to the object pattern is a down jacket, and wherein the object recognition device further outputs a down jacket non-existence signal when the object type corresponding to the object pattern is a non-down jacket; and
a switching unit configured to switch on the electric heater after receiving the down jacket existence signal.

10. The automatic switching device of claim 9, wherein the trigger processing device is configured to stop the implementation of the linear filtered image and the corresponding edge enhancement of the edge resolution when receiving the strong edge control signal.

11. The automatic switching device of claim 9, wherein the executing the numerical value adjustment for each sub-area division threshold to obtain the adjusted sub-area division threshold for each sub-image is further based on a difference between the overall division threshold and each sub-area division threshold.

12. The automatic switching device of claim 11, wherein the executing the numerical value adjustment for each sub-area division threshold to obtain the adjusted sub-area division threshold for each sub-image is further based on a condition that the each adjusted sub-area division threshold is equal to one quarter of the sum of each sub-area division threshold and the difference between the overall division threshold and each sub-area division threshold.
